(19) United States
(12) Patent Application Publication
(10) Pub. No.: US 2026/0007185 A1
(43) Pub. Date: Jan. 8, 2026

(54) AN AEROSOL GENERATING DEVICE

(71) Applicant: JT INTERNATIONAL SA, Geneva (CH)

(72) Inventors: Layth Sliman BOUCHUIGUIR, Bellevue (CH); Pier Paolo MONTICONE, Le Grand-Saconnex (CH)

(73) Assignee: JT INTERNATIONAL SA, Geneva (CH)

(21) Appl. No.: 18/881,750

(22) PCT Filed: Jun. 27, 2023
(86) PCT No.: PCT/EP2023/067385

§ 371 Date: Jan. 7, 2025

(30) Foreign Application Priority Data
Jul. 7, 2022 (EP) 22183560.6

(51) Int. Cl. A24F 40/60; A24F 40/20; A24F 40/51; A24F 40/57

(52) U.S. Cl. CPC A24F 40/60; A24F 40/20; A24F 40/51; A24F 40/57

(57) ABSTRACT

An aerosol generating device is described. The device is configured to atomise aerosol generating material to generate an aerosol for inhalation by a user, for example by heating the material or substrate. The device includes a first haptic actuator and a second haptic actuator. A controller of the device is configured to control the first and second haptic actuators to provide haptic feedback to the user during a vaping session.

### TECHNICAL FIELD

The present disclosure relates generally to an aerosol generating device, and in particular to a device that is configured to atomise or aerosolise aerosol generating material to generate an aerosol for inhalation by a user. The present disclosure is particularly applicable to a portable (hand-held) aerosol generating device.

The aerosol generating material may be part of an article that may be received in the device in use.

### TECHNICAL BACKGROUND

Devices which heat, rather than burn, an aerosol generating material to produce an aerosol for inhalation have become popular with consumers in recent years. A commonly available reduced-risk or modified-risk device is the heated material aerosol generating device, or so-called heat-not-burn device. Devices of this type generate an aerosol or vapour by heating an aerosol generating material to a temperature typically in the range 150° C. to 300° C. This temperature range is quite low compared to an ordinary cigarette. Heating the aerosol generating material to a temperature within this range, without burning or combusting the aerosol generating material, generates a vapour which typically cools and condenses to form an aerosol for inhalation by a user of the device. An aerosol may also be produced without heating (e.g., by using ultrasonic or chemical reaction), particularly if the device uses a liquid aerosol generating material or substrate.

It is known for such aerosol generating devices to provide a notification to the user using haptic feedback. As used herein, the term “haptic feedback” means any feedback that is capable of creating an experience or sensation of touch for the user, i.e., that generates a tactile response. A tactile response may be applied to the hand of the user that is holding the device, for example.

The device of the present disclosure aims to provide improved haptic feedback that optimises the sensory experience of the user during a vaping session and which may be responsive to environmental characteristics, for example.

### SUMMARY OF THE DISCLOSURE

According to a first aspect of the present disclosure, there is provided an aerosol generating device configured to atomise aerosol generating material to generate an aerosol for inhalation by a user, the device comprising:
a first haptic actuator;
a second haptic actuator that is different to the first haptic actuator; and
a controller configured to control the first and second haptic actuators to provide haptic feedback to the user during a vaping session. The controller may be configured to control the first and second haptic actuators so that haptic feedback is provided to the user by only the first haptic actuator during a first phase of a vaping session and haptic feedback is provided to the user by only the second haptic actuator during a second phase of a vaping session. The duration of the first phase may be longer than the duration of the second phase. The first haptic actuator may be more energy efficient than the second haptic actuator.

As described in more detail below, using two different haptic actuators may provide improved haptic feedback to the user and may optimise the efficiency of the device.

The first and second haptic actuators may be configured to provide haptic feedback using mechanical and/or electrical stimulation. For example, a tactile response may be generated using one or more of vibro-tactile feedback, force feedback and electro-tactile feedback (or electro-stimulation). Vibro-tactile feedback may be provided to the user of the device by using a vibration actuator to generate an oscillating or reciprocating motion of the device. Force feedback may be provided to the user of the device by using a force actuator to move the device. Electro-tactile feedback (or electro-stimulation) may be provided by using electrical pulses to stimulate the sensory system of the user of the device. The amplitude and frequency of the electrical pulses applied by an electrical actuator such as an array of electrodes may be varied to simulate a wide range of tactile responses. In each case, the haptic feedback may be used to provide a status notification or to otherwise communicate with, or provide information to, the user by means of the tactile response generated.

The first haptic actuator may be a vibration motor such as an eccentric rotating mass vibration motor, a piezoelectric actuator, a linear resonant actuator, or an electrical actuator such as electro-stimulation array or electro-tactile stimulator, for example.

A typical eccentric rotating mass vibration motor is a compact DC motor that spins an eccentric unbalanced mass to create a desired vibration. A wide range of such vibration motors are available at relatively low cost, but response times (starting and shutdown) are often slower than piezoelectric actuators and linear resonant actuators because of the operation of the DC motor. Some vibration motors are also not very energy efficient.

A typical piezoelectric actuator will use produce vibrations using piezoelectric material mounted in a cantilever beam configuration, for example. Piezoelectric actuators are thin, lightweight and have fast response times. They are also normally more energy efficient than vibration motors.

A typical linear resonant actuator is a spring-mass system that vibrates to provide haptic feedback. Linear resonant actuators are very energy efficient, reliable, and have simple amplitude control and fast response times.

An electro-stimulation array or electro-tactile stimulator may have any suitable construction and may be used to capture user input in addition to stimulating the user's sensory system to provide a tactile response. Moreover, an electro-stimulation array or electro-tactile stimulator is capable of targeting the haptic feedback to the parts of the user's hand that are in contact with the device. The electro-stimulation array or electro-tactile stimulator may comprise one or more electrodes that operate with electrical pulses using DC or AC current. The electro-stimulation array or electro-tactile stimulator may be exposed on an outer surface of the device or may be covered by a dielectric layer so that it is not in direct contact with the user's hand.

The device may further comprise a position sensing device for sensing the position of the user's hand on the device. The position sensing device may comprise one or more capacitance-based sensors that detect position by detecting changes in the capacitive field, for example. The position sensing device may be mounted on a flexible tactile layer or integrated with an electrical actuator such as an electro-stimulation array or electro-tactile stimulator. A position sensing device may be omitted if the device is shaped so that it can only be held in a certain way—i.e., so that there is no need to sense the position of the user's hand on the device when targeting the tactile response.

The second haptic actuator may be a vibration motor such as an eccentric rotating mass vibration motor, a piezoelectric actuator, a linear resonant actuator, or an electrical actuator such as an electro-stimulation array or electro-tactile stimulator, for example-but subject to the proviso that it should not be the same as the first haptic actuator. The first and second haptic actuators should not be identical, but they may both generate haptic feedback in the same way, e.g., by using an eccentric rotating mass or piezoelectric material. Put another way, the first and second haptic actuators may both be vibration motors, piezoelectric actuators or linear resonant actuators, for example, if the user is able to differentiate between the haptic feedback generated by each haptic actuator. Preferably, the first and second haptic actuators will generate haptic feedback in a different way so that the user can more easily differentiate between the haptic feedback that is provided by the different haptic actuators. For example, the first haptic actuator may be a linear resonant actuator and the second haptic actuator may be a piezoelectric actuator.

The first haptic actuator may be electrically connected to a first driver that is controlled by the controller and the second haptic actuator may be electrically connected to a second driver that is controlled by the controller. Each driver will be configured to operate its respective haptic actuator so that it provides the desired haptic feedback to the user. For example, the amplitude and/or frequency of the haptic feedback to be provided by each haptic actuator may be determined by the controller and the first and second drivers will operate or drive the respective haptic actuator accordingly.

Alternatively, a single driver may control both of the first and second haptic actuators. At least one of the first and second drivers may be omitted and at least one of the first and second haptic actuators may be directly controlled by the controller.

The aerosol generating device is typically a hand-held, portable, device.

The aerosol generating device may be configured to heat an aerosol generating material or substrate, without burning the aerosol generating material, to volatise at least one component of the aerosol generating material and thereby generate a heated vapour which cools and condenses to form an aerosol for inhalation by a user of the aerosol generating device. The device may generate an aerosol in other ways, e.g., by using an ultrasonic transducer to atomise a liquid aerosol forming substrate.

In general terms, a vapour is a substance in the gas phase at a temperature lower than its critical temperature, which means that the vapour may be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The device may comprise a heating chamber for receiving at least part of an aerosol generating material and a heating arrangement configured to heat the aerosol generating material to generate an aerosol. The heating arrangement may be an induction heating arrangement with an induction coil disposed around or adjacent to the heating chamber, or may comprise one or more heaters, e.g., a low power thin film heater, printed heater etc.

According to a second aspect of the present disclosure, there is provided an aerosol generating system comprising:
an aerosol generating material; and
an aerosol generating device as defined above for atomising the aerosol generating material to generate an aerosol to be inhaled.

The aerosol generating material may comprise any type of solid or semi-solid material. Example types of aerosol generating solids include powder, granules, pellets, shreds, strands, particles, gel, strips, loose leaves, cut filler, porous material, foam material or sheets. The aerosol generating material may comprise plant derived material and in particular, may comprise tobacco. It may advantageously comprise reconstituted tobacco, for example including tobacco and any one or more of cellulose fibres, tobacco stalk fibres and inorganic fillers such as CaCO3.

Consequently, the aerosol generating device may be referred to as a “heated tobacco device”, a “heat-not-burn tobacco device”, a “device for vaporising tobacco products”, and the like, with this being interpreted as a device suitable for achieving these effects.

The features disclosed herein are equally applicable to devices which are designed to vaporise any aerosol generating material, including a liquid material or substrate.

The aerosol generating material may form part of an aerosol generating article and may be surrounded by a paper wrapper.

The aerosol generating article may be formed substantially in the shape of a stick, and may broadly resemble a cigarette, having a tubular region with an aerosol generating material or substrate arranged in a suitable manner. The aerosol generating article may include a filter segment, for example comprising cellulose acetate fibres, at a proximal end of the aerosol generating article. The filter segment may constitute a mouthpiece filter and may be in coaxial alignment with the aerosol generating material. One or more vapour collection regions, cooling regions, and other structures may also be included in some designs. For example, the aerosol generating article may include at least one tubular segment upstream of the filter segment. The tubular segment may act as a vapour cooling region. The vapour cooling region may advantageously allow the heated vapour generated by heating the aerosol generating material to cool and condense to form an aerosol with suitable characteristics for inhalation by a user, for example through the filter segment.

The aerosol generating material may comprise an aerosol-former. Examples of aerosol-formers include polyhydric alcohols and mixtures thereof such as glycerine or propylene glycol. Typically, the aerosol generating material may comprise an aerosol-former content of between approximately 5% and approximately 50% on a dry weight basis. In some embodiments, the aerosol generating material may comprise an aerosol-former content of between approximately 10% and approximately 20% on a dry weight basis, and possibly approximately 15% on a dry weight basis.

Upon being heated, the aerosol generating material may release volatile compounds. The volatile compounds may include nicotine or flavour compounds such as tobacco flavouring.

The aerosol generating material may be a liquid material or substrate and the device may comprise an atomising arrangement to atomise the liquid material or substrate, including without heating.

The controller may be further configured to control the first and second haptic actuators so that haptic feedback is provided to the user by only the first haptic actuator during a first phase of the vaping session and haptic feedback is provided to the user by only the second haptic actuator during a second phase of the vaping session. The haptic feedback provided to the user during the first phase is therefore different from the haptic feedback provided to user during the second phase because different haptic actuators are used. Using different haptic actuators to provide the haptic feedback allows the user to more easily differentiate between the first and second phases of the vaping session as compared with known devices that use a single haptic actuator to provide the haptic feedback. The haptic feedback provided during each phase may be discrete—i.e., haptic feedback is provided for one or more periods of time and there are other periods of time where no haptic feedback is provided to the user—or the haptic feedback may be provided during substantially the whole of a phase. In the latter case, the haptic feedback may be substantially continuous during the particular phase of the vaping session, but its amplitude and/or frequency may be varied by the controller to vary the sensory experience of the user. The haptic feedback may be provided substantially continuously during the whole of the vaping session.

As mentioned above, the duration of the first phase may be longer than the duration of the second phase, and the first haptic actuator may be more efficient (e.g., more energy efficient) than the second haptic actuator. The relative energy efficiency of the first and second haptic actuators may be based on any suitable definition as will be understood by the skilled person such as the amount of output that can be produced for a given energy input. For example, the first haptic actuator may consume less electrical power than the second haptic actuator when actuated for the same length of time, or when providing broadly equivalent haptic feedback to the user, or the first haptic actuator may have a lower power rating than the second haptic actuator. In the case of vibration or force haptic actuators, for example, energy efficiency might be defined as the amount of mechanical energy that the haptic actuator produces for a given input of electrical energy. Energy efficiency of each haptic actuator may be defined by the current value supplied to each haptic actuator under the same or similar operating conditions. The operating conditions may include one or more of environmental conditions (e.g., ambient temperature, pressure or humidity), physical device conditions (e.g., device temperature, load resistance etc.) or command conditions (e.g., an operational mode of the device, command duty ratio or command frequency). Efficiency of the first and second haptic actuators may also be defined in terms of the ratio between perceived haptic intensity and input electrical energy, for example. Perceived haptic intensity may be based on the mechanical energy generated by the haptic actuator and the tactile response generated by the haptic actuator, e.g., the mechanical energy generated by the haptic actuator multiplied by the sensitivity curve of the stimulated receptor in the target area of the user. If multiple receptors are stimulated by the same haptic actuator, a weighted sum or average can be used to determine the perceived haptic intensity. The input electrical energy may be the real power supplied to the haptic actuator, or the reactive power depending on circuit design. The first phase may be a pre-heating or heating phase of the vaping session. A pre-heating phase may generally be intended to pre-heat the aerosol generating material to a target temperature, and the heating or vaping phase may be generally intended to heat the aerosol generating material for a longer period during which an aerosol is generated. The second phase may be a start phase or an end phase of the vaping session, for example. The start phase may be when the device is turned on at the start of a vaping session and before a pre-heating phase. An end phase may be when the vaping session is about to end and after a heating or vaping phase. The device may transition from a heating or vaping phase to an end phase after the user has taken a predefined number of puffs, or after a period of time has elapsed, for example. Using a more energy efficient haptic actuator during the first phase improves the energy efficiency of the device because less electrical power is needed to provide haptic feedback to the user during this phase, which may represent a significant proportion of the duration of the vaping session. The first haptic actuator may be a linear resonant actuator, for example, because it is very energy efficient. The second haptic actuator may be any different haptic actuator. For example, the second haptic actuator may be a vibration motor such as an eccentric rotating mass vibration motor, a piezoelectric actuator, or an electrical actuator such as an electro-stimulation array or electro-tactile stimulator. The second haptic actuator may also be a different type of linear resonant actuator.

The controller may be further configured to control the first and second haptic actuators so that haptic feedback is provided to the user by only the first haptic actuator during one or both of a pre-heating phase and a heating or vaping phase, and haptic feedback is provided to the user only by the second haptic actuator during one or both of a start phase and an end phase.

The controller may be further configured to control the first and second haptic actuators so that haptic feedback is provided simultaneously to the user by the first and second haptic actuators in a third phase of the vaping session. The phase may be a start phase, a pre-heating phase, a heating or vaping phase, or an end phase, for example. In another phase, the haptic feedback may be provided by only the first haptic actuator or the second haptic actuator so that different haptic feedback is provided to the user in different phases. If haptic feedback is provided simultaneously by the first and second haptic actuators, the individual haptic feedback provided by each haptic actuator may be synchronised, e.g., so that they have the same frequency or so that one frequency is an integer multiple of the other frequency. The controller may be further configured to control at least one of the first and second haptic actuators to vary the amplitude and/or frequency of the haptic feedback provided to the user during the phase.

The controller may be configured to control the first and second haptic actuators to provide varying haptic feedback to the user during substantially the whole of the vaping session or during substantially the whole of a phase of the vaping session. It will be readily understood that such control may include one of the first and second haptic actuators not providing any haptic feedback to the user during one or more phases of the vaping session. For example, during a first phase, the first haptic actuator may be controlled to provide haptic feedback to the user while the second haptic actuator is not operated and, during a second phase, the second haptic actuator may be controlled to provide haptic feedback to the user while the first haptic actuator is not operated. In other words, a haptic actuator may be controlled to not operate for one or more phases of the vaping session as long as varying haptic feedback is provided to the user during substantially the whole of the vaping session or the phase.

The controller may be further configured to control at least one of the first and second haptic actuators to provide haptic feedback to the user, or to vary the haptic feedback that is being provided to the user, in response to one or more of the following, for example:
a puff detection,
a temperature of the device, e.g., a temperature measured in a heating chamber of the device that is configured to receive an aerosol generating article,
an operating condition of the device, e.g., on start, when the device transitions between different phases, or when a puff limit or time limit for the vaping session is about to be reached which might involve a transition to an end phase,
an environmental characteristic, e.g., ambient noise or ambient temperature,
a vibration or movement of the device, and
how the device is held by the user, e.g., how tightly the user's hand is gripping the device.

If the vaping session includes a plurality of phases, the controller may be further configured to control the first and second haptic actuators to provide different haptic feedback to the user during each phase. It will be readily understood that such control may include one of the first and second haptic actuators not providing any haptic feedback to the user during one or more phases of the vaping session. For example, during a first phase, the first haptic actuator may be controlled to provide haptic feedback to the user while the second haptic actuator is not operated and, during a second phase, the second haptic actuator may be controlled to provide haptic feedback to the user while the first haptic actuator is not operated. In other words, a haptic actuator may be controlled to not operate for one or more phases of the vaping session and the use of different haptic actuators in different phases may be sufficient to provide different haptic feedback. Providing different haptic feedback allows the user to distinguish between the phases of the vaping session more easily. The controller may be configured to control the first haptic actuator to provide haptic feedback to the user during substantially the whole of the first phase of the vaping session and/or to control the second haptic actuator to provide haptic feedback to the user during substantially the whole of the second phase of the vaping session.

If the vaping session includes a pre-heating phase (e.g., as the first phase), the controller may be further configured to control at least one of the first and second haptic actuators to vary the amplitude and/or frequency of the haptic feedback provided to the user based on a temperature of the device. For example, the amplitude and/or frequency of the haptic feedback may be increased (or decreased) during the pre-heating phase in response to an increasing measured temperature. The haptic feedback may therefore provide the user with information about the progress of the pre-heating phase and consequently when the device may be about to transition to a subsequent heating or vaping phase. During the pre-heating phase one of the first and second haptic actuators may be controlled not to be operated, e.g., the haptic feedback may be provided only by the first haptic actuator. The same control may be applied to a heating or vaping phase of the vaping session where the temperature of the device may vary based on a temperature profile that controls the heating of the aerosol generating material, for example. The temperature may be a temperature measured by a temperature sensor located in the heating chamber of the device.

If the vaping session includes a heating or vaping phase (e.g., as the first phase), the controller may be further configured to control at least one of the first and second haptic actuators to vary the amplitude and/or frequency of the haptic feedback provided to the user when a puff is detected. For example, the amplitude and/or frequency of the haptic feedback may be temporarily increased (or decreased) after a puff is detected. This may improve the user experience. The amplitude and/or frequency of the haptic feedback may be temporarily increased (or decreased) based on the strength of the puff. The haptic feedback may therefore provide the user with information about the strength of the puff, which may affect the duration of the vaping session. During the heating or vaping phase one of the first and second haptic actuators may be controlled not to be operated, e.g., the haptic feedback may be provided only by the first haptic actuator. Each puff may be detected by a puff detection sensor, for example.

The controller may be further configured to control at least one of the first and second haptic actuators to vary the amplitude and/or frequency of the haptic feedback provided to the user based on one or more environmental characteristics such as ambient noise and ambient temperature, or how the device is being moved or held by the user. This allows the haptic feedback to better adapt to the environment in which the device is being used. For example, the amplitude of the haptic feedback may be increased in response to an increase in measured ambient noise or the motion of the device, which may indicate that the device is being used in a busy or noisy environment where it might be more difficult for the user to sense the haptic feedback. If the device is being gripped tightly by the user, the amplitude of the haptic feedback may be decreased or vice versa, for example.

The device may further include one or more of a temperature sensor for measuring the ambient temperature (i.e., the temperature of the air surrounding the device), a noise sensor for measuring ambient noise (i.e., the background noise present in the environment where the device is located), a vibration sensor for measuring vibration of the device, a movement sensor for measuring movement of the device, and a strain gauge or other force sensor for measuring how tightly the device is being gripped by the user's hand. If the device includes a microphone sensor as an inhalation or puff detector, the microphone sensor may also be used as the noise sensor.

According to a third aspect of the present disclosure, there is provided a method of controlling an aerosol generating device during a vaping session, the aerosol generating device being configured to atomise aerosol generating material to generate an aerosol for inhalation by a user and comprising a first haptic actuator and a second haptic actuator that is different to the first haptic actuator, wherein the method comprises controlling the first and second haptic actuators to provide haptic feedback to the user during a vaping session. The first and second haptic actuators may be controlled so that haptic feedback is provided to the user by only the first haptic actuator during a first phase of the vaping session and haptic feedback is provided to the user by only the second haptic actuator during a second phase of the vaping session. The duration of the first phase may be longer than the duration of the second phase. The first haptic actuator may be more energy efficient than the second haptic actuator.

The first haptic actuator may be a linear resonant actuator.

The first phase may be a pre-heating or heating phase of the vaping session and the second phase may be a start or end phase of the vaping session, for example.

The method may further comprise controlling the first and second haptic actuators so that haptic feedback is provided simultaneously to the user by the first and second haptic actuators in a third phase of the vaping session.

Other features of the aerosol generating device and the method may be as described above.

### BRIEF DESCRIPTION OF THE DRAWINGS

FIG. 1 is a diagrammatic cross-sectional view of an aerosol generating system comprising an aerosol generating device and an aerosol generating article ready to be positioned in a heating chamber of the aerosol generating device;

FIG. 2 is a diagrammatic cross-section view of an aerosol generating system where the haptic actuator is an electro-stimulation array:

FIG. 3 is a representation of haptic feedback provided to a user of the aerosol generating device during a vaping session:

FIGS. 4A and 4B are representations of haptic feedback provided by first and second haptic actuators of the device during the vaping session:

FIG. 5 is a representative of the haptic feedback provided to the user of the aerosol generating device during an alternative vaping session; and

FIGS. 6A and 6B are representative of haptic feedback provided by first and second haptic actuators of the device during the alternative vaping session.

### DETAILED DESCRIPTION OF EMBODIMENTS

Embodiments of the present disclosure will now be described by way of example only and with reference to the accompanying drawings.

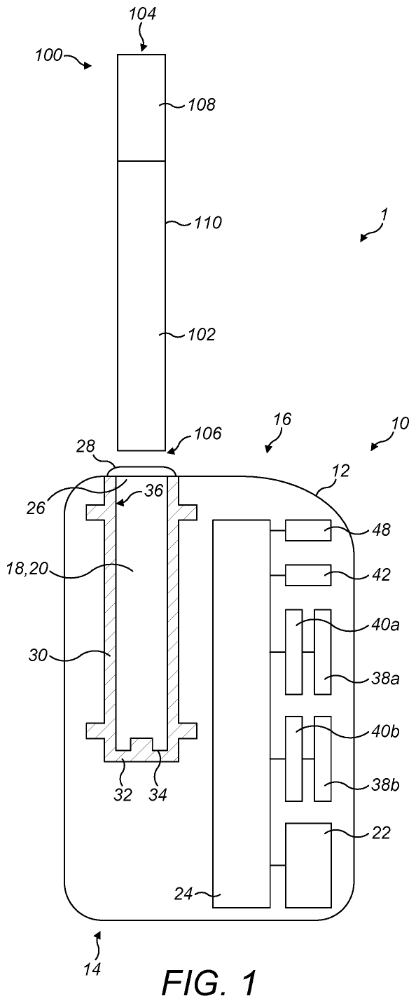

Referring initially to FIG. 1, there is shown diagrammatically an example of an aerosol generating system 1. The aerosol generating system 1 comprises an aerosol generating device 10 and an aerosol generating article 100 for use with the device 10. The aerosol generating device 10 comprises a main body 12 housing various components of the aerosol generating device 10. The main body 12 may have any shape that is sized to fit the components described in the various embodiments set out herein and to be comfortably held by a user unaided, in a single hand.

A first end 14 of the aerosol generating device 10, shown towards the bottom of FIG. 1, is described for convenience as a distal, bottom, base or lower end of the aerosol generating device 10. A second end 16 of the aerosol generating device 10, shown towards the top of FIG. 1, is described as a proximal, top or upper end of the aerosol generating device 10. During use, the user typically orients the aerosol generating device 10 with the first end 14 downward and/or in a distal position with respect to the user's mouth and the second end 16 upward and/or in a proximate position with respect to the user's mouth.

The aerosol generating device 10 comprises a heating chamber 18 positioned in the main body 12. The heating chamber 18 defines an interior volume in the form of a cavity 20 having a substantially cylindrical cross-section for receiving an aerosol generating article 100. The heating chamber 18 has a longitudinal axis defining a longitudinal direction and is formed of a heat-resistant plastics material, such as polyether ether ketone (PEEK). The aerosol generating device 10 further comprises a power source 22, for example one or more batteries which may be rechargeable, and a controller 24. The controller 24 may comprise one or more integrated circuit and other electrical components. For example, an integrated circuit may comprise at least one of a microcontroller unit (MCU) and microprocessor unit (MPU).

The heating chamber 18 is open towards the second end 16 of the aerosol generating device 10. In other words, the heating chamber 18 has an open first end 26 towards the second end 16 of the aerosol generating device 10. The heating chamber 18 is typically held spaced apart from the inner surface of the main body 12 to minimise heat transfer to the main body 12.

The aerosol generating device 10 may optionally include a sliding cover 28 movable transversely between a closed position (shown in FIG. 1) in which it covers the open first end 26 of the heating chamber 18 to prevent access to the heating chamber 18 and an open position (not shown) in which it exposes the open first end 26 of the heating chamber 18 to provide access to the heating chamber 18. The sliding cover 28 may be biased to the closed position in some embodiments.

The heating chamber 18, and specifically the cavity 20, is arranged to receive a correspondingly shaped generally cylindrical or rod-shaped aerosol generating article 100. Typically, the aerosol generating article 100 comprises a pre-packaged aerosol generating material or substrate 102. The aerosol generating article 100 is a disposable and replaceable article (also known as a “consumable”) which may, for example, contain tobacco as the aerosol generating material 102. The aerosol generating article 100 has a proximal end 104 (or mouth end) and a distal end 106. The aerosol generating article 100 further comprises a mouthpiece segment 108 positioned downstream of the aerosol generating material 102. The aerosol generating material 102 and the mouthpiece segment 108 are arranged in coaxial alignment inside a wrapper 110 (e.g., a paper wrapper) to hold the components in position to form the rod-shaped aerosol generating article 100.

The mouthpiece segment 108 may comprise one or more of the following components (not shown in detail) arranged sequentially and in co-axial alignment in a downstream direction, in other words from the distal end 106 towards the proximal (mouth) end 104 of the aerosol generating article 100: a cooling segment, a centre hole segment and a filter segment. The cooling segment typically comprises a hollow paper tube having a thickness which is greater than the thickness of the wrapper 110. The centre hole segment may comprise a cured mixture containing cellulose acetate fibres and a plasticizer, and functions to increase the strength of the mouthpiece segment 108. The filter segment typically comprises cellulose acetate fibres and acts as a mouthpiece filter. As heated vapour flows from the aerosol generating material 102 towards the proximal (mouth) end 104 of the aerosol generating article 100, the vapour cools and condenses as it passes through the cooling segment and the centre hole segment to form an aerosol with suitable characteristics for inhalation by a user through the filter segment.

The heating chamber 18 has a side wall (or chamber wall) 30 extending between a base 32, located at a second end 34 of the heating chamber 18, and the open first end 26. The side wall 30 and the base 32 are connected to each other and may be integrally formed as a single piece. In the illustrated embodiment, the side wall 30 is tubular and, more specifically, cylindrical. The side wall 30 may be formed so that the cross-section of the heating chamber 18 is a perfect circle or an ellipse. In other embodiments, the side wall 30 may have other suitable shapes, such as a tube with an elliptical or polygonal cross section. In yet further embodiments, the side wall 30 may be tapered.

In the illustrated embodiment, the base 32 of the heating chamber 18 is closed, e.g., sealed or air-tight. That is, the heating chamber 18 is cup-shaped. This may ensure that air drawn from the open first end 26 is prevented by the base 32 from flowing out of the second end 34 and is instead guided through the aerosol generating material 102. It may also ensure that a user inserts the aerosol generating article 100 into the heating chamber 18 an intended distance and no further.

The device 10 includes a heating arrangement 36, which is configured to heat the aerosol generating material 102 when the aerosol generating article 100 is received in the heating chamber 18.

The device 10 includes a first haptic actuator 38a which is electrically connected to the controller 24 by a first driver 40a, and a second haptic actuator 38b which is electrically connected to the controller by a second driver 40b. The type of driver is selected for the respective haptic actuator. When controlled by the controller 24, the first and second drivers 40a, 40b operate the first and second haptic actuators 38a, 38b to provide haptic feedback to the user. The first haptic actuator 38a is a linear resonant actuator and the second haptic actuator 38b is a piezoelectric actuator. Alternatively, a single driver may control both of the first and second haptic actuator 38a, 38b. In another embodiment, at least one of the first and second drivers 40a, 40b may be omitted and at least one of the first and second haptic actuators 38a, 38b is controlled directly by the controller 24.

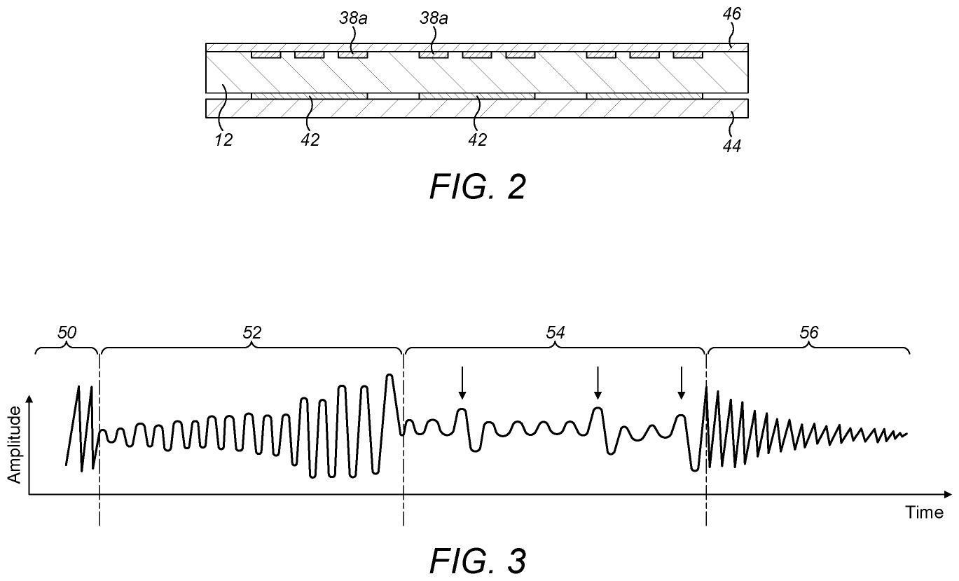

If one of the first and second haptic actuators 38a, 38b is an electrical actuator such as an electro-simulation array or electro-tactile stimulator, for example, the device 10 may include a position sensing electrode 42 which is electrically connected to the controller 24. Referring to FIG. 2, the position sensing electrode 42 may be formed on a flexible tactile layer 44. The electrical actuator (i.e., the first haptic actuator 38a) is formed on an outer surface of the main body 12 and covered by a dielectric layer or coating 46, e.g., a layer of dielectric paint or layer of plastics material. There is no direct contact between the user's hand and the electrical actuator. In another embodiment, the dielectric layer or coating 46 may be omitted so that there is direct contact between the user's hand and the electrical actuator. In another embodiment, the position sensing electrode 42 may be integrated with the electrical actuator to define an array that is capable of both position sensing and providing electro-tactile stimulation. The position sensing electrode 42 may also be omitted if the device is shaped so that it can only be held in a certain way and there is no need to detect the position of the user's hand in order to target the tactile response.

The device 10 includes one or more sensors 48 which are electrically connected to the controller 24.

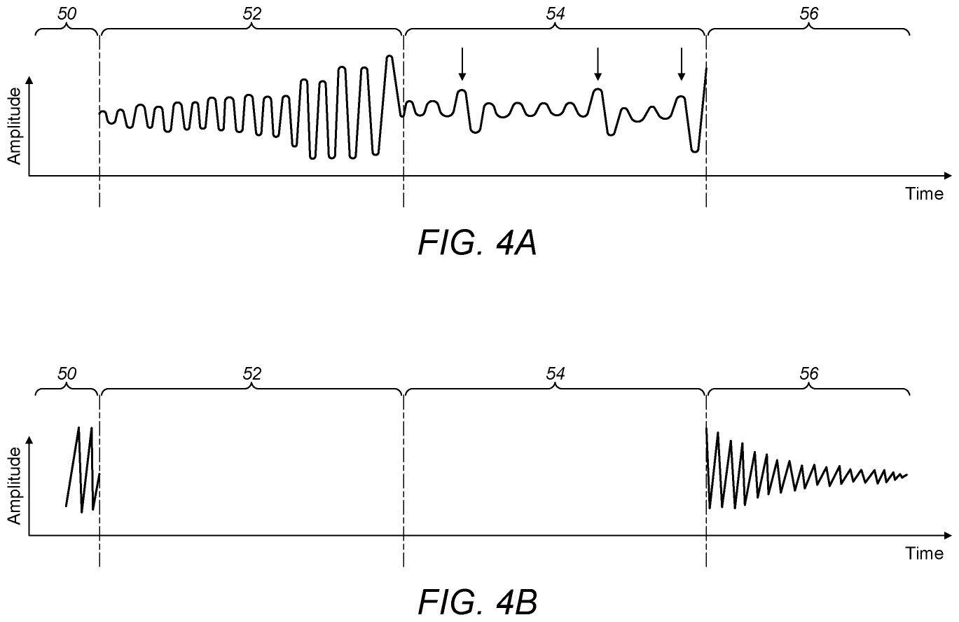

Referring to FIGS. 3, 4A and 4B, a vaping session includes a start phase 50, a pre-heating phase 52, a heating or vaping phase 54, and an end phase 56. FIG. 3 is representative of the haptic feedback provided to the user by the first and second haptic actuators 38a, 38b over the whole of the vaping session. FIG. 4A is representative of the haptic feedback provided to the user by the first haptic actuator 38a and FIG. 4B is representative of the haptic feedback provided to the user by the second haptic actuator 38b.

The start phase 50 is when the aerosol generating device 10 is turned on. The start phase 50 is relatively short and haptic feedback is provided to the user by the second haptic actuator 38b. More particularly, the controller 24 controls the second driver 40b to operate the second haptic actuator 38b to provide haptic feedback to the user continuously during the start phase 50. The amplitude and frequency of the haptic feedback is not varied during the start phase 50.

The pre-heating phase 52 is when the aerosol generating material 110 is being heated towards a target temperature. When the vaping session transitions to the pre-heating phase 52, the controller 24 controls the second driver 40b to stop operation of the second haptic actuator 38b. The controller 24 controls the first driver 40a to operate the first haptic actuator 38a to provide haptic feedback to the user continuously during the pre-heating phase 52. The sensors 48 include a temperature sensor positioned to measure the temperature within the heating chamber 18. As the heating arrangement 36 heats the aerosol generating material 102, the temperature measured by the temperature sensor increases. The controller 24 controls the first driver 40a to operate the first haptic actuator 38a so that the amplitude of the haptic feedback provided by the first haptic actuator 38a increases based on the measured temperature. This allows the user to follow the progress of the pre-heating phase more clearly.

When the target temperature has been reached, the vaping session transitions to the heating (or vaping) phase 54 where the aerosol generating material 110 is heated for a longer period during which an aerosol is generated and inhaled by the user by taking several puffs through the mouthpiece segment 108 of the aerosol generating article 100. Alternatively, the vaping session may remain in the pre-heating phase 52 for a short time after the target temperature has been reached. The controller 24 controls the first driver 40a to operate the first haptic actuator 38a to provide haptic feedback to the user continuously during the heating phase 54. The frequency of the haptic feedback provided during the heating phase 54 is different from the frequency of the haptic feedback provided during the pre-heating phase 52. The sensors 48 include a puff detector to detect when the user takes a puff. In FIGS. 3, 4A, 5 and 6A each puff is indicated by a vertical arrow. In response to a detected puff, the controller 24 controls the first driver 40a to temporarily increase the amplitude of the haptic feedback. This allows the user to more clearly feel when a puff is taken. It should be noted that this increase of the amplitude of the haptic feedback is just temporary and the amplitude will fall back to the usual value or range fairly quickly. Until the next puff is detected, the amplitude of the haptic feedback that is provided to the user will be kept at this usual value or range.

The vaping session transitions to an end phase 56, e.g., after a certain number of puffs have been taken. The controller 24 controls the first driver 40a to stop operation of the first haptic actuator 38a. The controller 24 controls the second driver 40b to operate the second haptic actuator 38b to provide haptic feedback to the user continuously during the end phase 56. The frequency of the haptic feedback provided during the end phase 56 is different from the frequency of the haptic feedback provided during the heating phase 54. The controller 24 controls the second driver 40b to operate the second haptic actuator 38b so that the amplitude of the haptic feedback provided by the second haptic actuator 38b decreases during the end phase 56. This allows the user to follow the progress of the end phase and the conclusion of the vaping session more clearly.

The duration of the pre-heating and heating phases 52, 54 is greater than the duration of the start and end phases 50, 56. More particularly, the pre-heating and heating phases 52, 54 represent a significant proportion of the total duration of the vaping session. Since haptic feedback is provided continuously to the user over the course of the vaping session, using a more energy efficient linear resonant actuator as the first haptic actuator 38a provides significant power savings because it is operated for a relatively longer period of time. Different haptic feedback is also provided to the user by the second haptic actuator 38b (i.e., the less energy efficient piezoelectric actuator) during the relatively shorter start and end phases 50, 56.

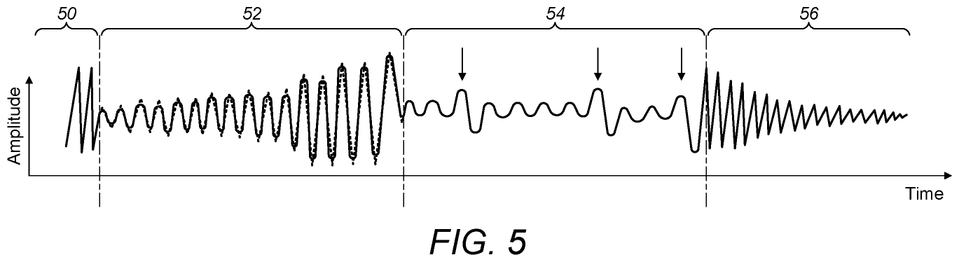

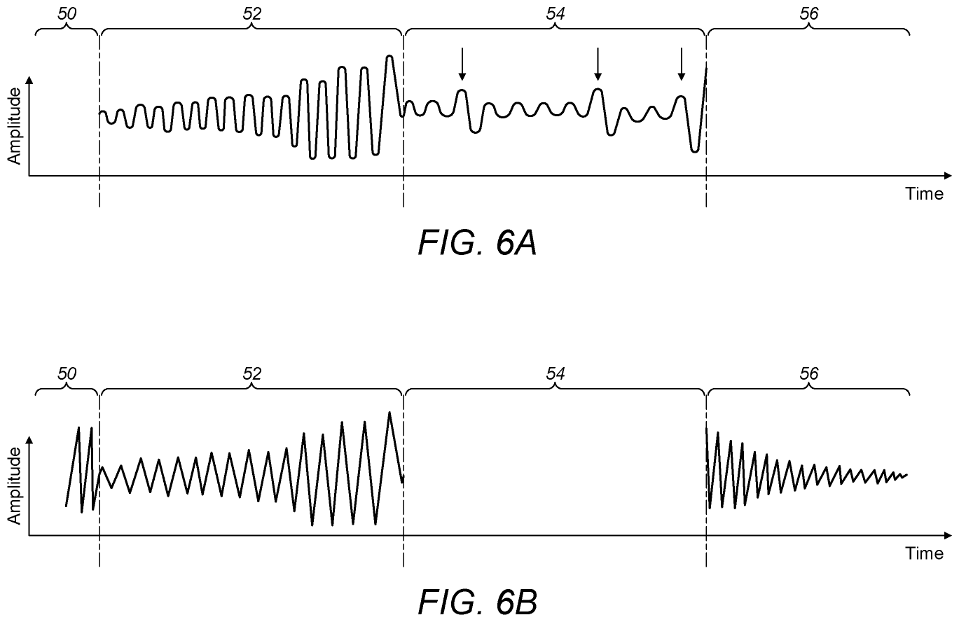

Referring to FIGS. 5, 6A and 6B, an alternative vaping session also includes a start phase 50, a pre-heating phase 52, a heating or vaping phase 54, and an end phase 56. FIG. 5 is representative of the haptic feedback provided to the user by the first and second haptic actuators 38a, 38b over the whole of the vaping session. FIG. 6A is representative of the haptic feedback provided to the user by the first haptic actuator 38a and FIG. 6B is representative of the haptic feedback provided to the user by the second haptic actuator 38b.

The alternative vaping session is similar to the vaping session described above, but in the pre-heating phase 52 the controller 24 controls the first and second drivers 40a, 40b to operate the first and second haptic actuators 38a, 38b to simultaneously provide haptic feedback to the user continuously during the pre-heating phase 52. (In FIG. 5 the haptic feedback provided by the second haptic actuator 38b during the pre-heating phase 52 is shown in dashed lines so that it can be more clearly distinguished from the haptic feedback provided by the first haptic actuator 38a, which is shown in solid line.) The individual haptic feedback provided by the first and second haptic actuators 38a, 38b is synchronised to have the same frequency, or a frequency which is an integer multiple of the other frequency. The controller 24 controls the first and second drivers 40a, 40b to operate the first and second haptic actuators 38a, 38b so that the amplitude of the haptic feedback provided by the first and second haptic actuators increases based on the measured temperature. This allows the user to follow the progress of the pre-heating phase more clearly.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments. For example, the aerosol generating device may be of a type that does not heat the aerosol generating material or substrate to generate an aerosol for inhalation by the user. Different types of haptic actuators may also be used.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating device configured to atomise aerosol generating material to generate an aerosol for inhalation by a user, the device comprising:
a first haptic actuator;
a second haptic actuator); and
circuitry configured to control the first and second haptic actuators so that haptic feedback is provided to the user by only the first haptic actuator during a first phase of a vaping session and haptic feedback is provided to the user by only the second haptic actuator during a second phase of the vaping session,
wherein
the duration of the first phase is longer than the duration of the second phase.

2.-15. (canceled)

16. The aerosol generating device of claim 1, wherein
an energy efficiency of the first haptic actuator is greater than an energy efficiency of the second haptic actuator.

17. The aerosol generating device of claim 1, wherein
the first haptic actuator is a linear resonant actuator.

18. The aerosol generating device of claim 17, wherein
the second haptic actuator is a piezoelectric actuator.

19. The aerosol generating device of claim 1, wherein
the circuitry is configured to control the first haptic actuator to provide haptic feedback to the user during substantially the whole of the first phase of the vaping session.

20. The aerosol generating device of claim 1, wherein
the circuitry is configured to control the second haptic actuator to provide haptic feedback to the user during substantially the whole of the second phase.

21. The aerosol generating device of claim 1, wherein
the circuitry is configured to control at least one of the first and second haptic actuators to provide haptic feedback to the user, or to vary the haptic feedback that is being provided to the user, in response to one or more of the following:
a puff detection,
a temperature of the device,
an operating condition of the device,
an environmental characteristic,
a vibration or movement of the device, and
how the user holds the device.

22. The aerosol generating device of claim 1, wherein
the first phase of the vaping session is a pre-heating phase, and
the circuitry is configured to control the first haptic actuator to vary at least one of an amplitude and a frequency of the haptic feedback provided to the user during the pre-heating phase based on a temperature of the device.

23. The aerosol generating device of claim 1, wherein
the first phase of the vaping session is a heating or vaping phase, and
the circuitry is configured to control the first haptic actuator to vary at least one of an amplitude and a frequency of the haptic feedback provided to the user during the heating or vaping phase when a puff is detected.

24. The aerosol generating device of claim 1, wherein
the second phase of the vaping session is a start phase or an end phase.

25. A method of controlling an aerosol generating device during a vaping session, the aerosol generating device configured to atomise aerosol generating material to generate an aerosol for inhalation by a user and comprising a first haptic actuator and a second haptic actuator, wherein the method comprises:
controlling the first and second haptic actuators so that haptic feedback is provided to the user by only the first haptic actuator during a first phase of the vaping session and haptic feedback is provided to the user by only the second haptic actuator during a second phase of the vaping session, wherein
the duration of the first phase is longer than the duration of the second phase.

26. The method of claim 25, wherein
an energy efficiency of the first haptic actuator is greater than an energy efficiency of the second haptic actuator.

27. The method of claim 25, wherein
the first haptic actuator is a linear resonant actuator.

28. The method of claim 27, wherein
the second haptic actuator is a piezoelectric actuator.

29. The method of claim 25, further comprising:
controlling the first haptic actuator to provide haptic feedback to the user during substantially the whole of the first phase of the vaping session; and/or
controlling the second haptic actuator to provide haptic feedback to the user during substantially the whole of the second phase of the vaping session.

30. The method of claim 25, further comprising:
controlling at least one of the first and second haptic actuators to provide haptic feedback to the user, or to vary the haptic feedback that is being provided to the user, in response to one or more of the following:
puff detection,
a temperature of the device,
an operating condition of the device,
an environmental characteristic,
a vibration or movement of the device, and
how the user holds the device.

31. The method of claim 25, wherein
the first phase of the vaping session is a pre-heating phase, and
the method comprises controlling the first haptic actuator to vary at least one of an amplitude and a frequency of the haptic feedback provided to the user during the pre-heating phase based on a temperature of the device.

32. The method of claim 25, wherein
the first phase of the vaping session is a heating or vaping phase, and
the method comprises controlling the first haptic actuator to vary at least one of an amplitude and a frequency of the haptic feedback provided to the user during the heating or vaping phase when a puff is detected.

33. The method of claim 25, wherein
the second phase of the vaping session is a start phase or an end phase.

34. The method of claim 25, further comprising:
controlling the first and second haptic actuators so that haptic feedback is provided simultaneously to the user by the first and second haptic actuators in a third phase of the vaping session.
